(19) United States
(12) Patent Application Publication
(10) Pub. No.: US 2009/0225738 A1
(43) Pub. Date: Sep. 10, 2009

(54) SYSTEMS AND METHODS FOR TRANSMITTING CHANNEL QUALITY INDICATORS FOR MUTLIPLE SUB-BANDS

(75) Inventors: Shugong Xu, Vancouver, WA (US); Kimihiko Imamura, Vancouver, WA (US)

Correspondence Address: AUSTIN RAPP & HARDMAN, 170 SOUTH MAIN STREET, SUITE 735, SALT LAKE CITY, UT, 84101, US

(73) Assignee: Sharp Laboratories of America, Inc., Camas, WA (US)

(21) Appl. No.: 12/042,986

(22) Filed: Mar. 5, 2008

(51) Int. Cl. H04J 1/00

(52) U.S. Cl. 370/343

(57) ABSTRACT

A method for using an uplink control channel to transmit a channel quality indicator (CQI) for sub-bands of a frequency bandwidth is described. The uplink control channel is provided in a format. The uplink control channel in the format is capable of carrying more than two bits of information. One or more CQIs are inserted into the uplink control channel. Each of the one or more CQIs is associated with one or more sub-bands of the frequency bandwidth. Each CQI uses up to three bits. The one or more CQIs are transmitted through the uplink control channel from a first device in a persistent scheduling mode to a second device.

### CROSS-REFERENCE TO RELATED APPLICATIONS

This application is related to U.S. patent application Ser. No. 11/876,412 entitled “Systems and Methods for Using a Format of an Uplink Control Channel to Transmit a Channel Quality Indicator,” which was filed on Oct. 22, 2007 and U.S. patent application Ser. No. 11/855,902 entitled “Method and System for Transmission of Channel Quality Indicators (CQIx) by Mobile Devices in a Wireless Communications Network,” which was filed on Sep. 14, 2007.

### TECHNICAL FIELD

The present disclosure relates generally to communications and wireless communications systems. More specifically, the present disclosure relates to systems and methods for transmitting a channel quality indicator for multiple sub-bands.

### BACKGROUND

The 3rd Generation Partnership Project, also referred to as “3GPP,” is a collaboration agreement that aims to define globally applicable Technical Specifications and Technical Reports for 3rd Generation Systems. 3GPP Long Term Evolution (LTE) is the name given to a project to improve the Universal Mobile Telecommunications System (UMTS) mobile phone or device standard to cope with future requirements. The 3GPP may define specifications for the next generation mobile networks, systems, and devices. In one aspect, UMTS has been modified to provide support and specification for the Evolved Universal Terrestrial Radio Access (E-UTRA) and Evolved Universal Terrestrial Radio Access Network (E-UTRAN). In 3GPP LTE (E-UTRA and E-UTRAN) terminology, a base station is called an “evolved NodeB” (eNB) and a mobile terminal or device is called “user equipment” (UE).

In 3GPP LTE, the eNB regularly transmits a downlink reference symbol (DLRS) that is used by the UEs for channel measurement, such as signal-to-interference ratio (SINR), which may be represented by a channel quality indicator (CQI). Each UE regularly transmits CQIs back to the eNB to enable the eNB to perform resource scheduling. Resource scheduling means the eNB allocates the modulation schemes, coding rates and subcarrier frequencies to optimize the downlink and uplink transmissions for each UE.

The data transmitted over a wireless network may be categorized as either non-real-time (NRT) data or real-time (RT) data. Examples of NRT data include data transmitted during web browsing by a UE or text-messaging to a UE, while an example of RT data is voice communication between UEs. The typical manner of resource scheduling for NRT data is dynamic scheduling by the eNB to each UE at each transmission time interval (TTI). During dynamic scheduling, the UE regularly transmits CQIs back to the eNB.

However, in 3GPP LTE the UEs are also required to transmit and receive RT data, specifically voice data which may be carried as Voice over Internet Protocol (VoIP) transmissions. A typical VoIP session has periodic small data packets at fixed intervals and periodic silence indication (SID) packets at fixed intervals. Unlike NRT data transmission, VoIP transmission is handled using persistent scheduling. In contrast to dynamic scheduling, in persistent scheduling when a UE's downlink reception is enabled, if the UE cannot find its resource allocation, a downlink transmission according to a predefined resource allocation is assumed.

VoIP transmission and its associated persistent method of resource allocation present special issues regarding the transmission of CQIs by the UEs through an uplink control channel for each sub-band of a frequency bandwidth. As such, benefits may be realized by providing systems and methods for transmitting channel quality indicators for multiple sub-bands.

### BRIEF DESCRIPTION OF THE DRAWINGS

FIG. 1 illustrates an exemplary wireless communication system in which configurations may be practiced;

FIG. 2 is a high-level block diagram of exemplary control protocol stacks of a base station, such as an evolved NodeB (eNB), and a user equipment (UE);

FIG. 3 is a block diagram of one configuration of the eNB and the UE;

FIG. 4 is a flow diagram illustrating one example of a method for providing CQI in an uplink (UL) control channel for one or more sub-bands of a frequency bandwidth;

FIG. 5 is a flow diagram illustrating one example of a method for allocating resources for a UL control channel;

FIG. 6 is a block diagram illustrating one example of the distribution of CQI differential information when multiple sub-bands are configured by the eNB;

FIG. 7 is a block diagram illustrating another example of the distribution of CQI differential information when multiple sub-bands are selected by the UE;

FIG. 8 is a block diagram illustrating an example of the distribution of CQI information when multiple sub-bands are selected by the UE;

FIG. 9 is a block diagram illustrating an example of the distribution of CQI information when multiple sub-bands are configured by the eNB;

FIG. 10 is a thread diagram illustrating one example of persistent scheduling communication in accordance with the present systems and methods;

FIG. 11 illustrates various components that may be utilized in a communications device; and

FIG. 12 illustrates various components that may be utilized in a base station.

### DETAILED DESCRIPTION

A method for using an uplink control channel to transmit a channel quality indicator (CQI) for sub-bands of a frequency bandwidth is described. The uplink control channel is provided in a format. The uplink control channel in the format is capable of carrying more than two bits of information. One or more CQIs are inserted into the uplink control channel. Each of the one or more CQIs is associated with one or more sub-bands of the frequency bandwidth. Each CQI uses up to three bits. The one or more CQIs are transmitted through the uplink control channel from a first device in a persistent scheduling mode to a second device.

In one example, the uplink control channel is a Physical Uplink Control Channel (PUCCH). The uplink control channel may be in Format 2 and may carry up to ten bits of information. One or more CQI differential values may be inserted into the uplink control channel. The CQI differential value may use a single bit.

The one or more sub-bands may be selected by mobile user equipment (UE). A sub-band position indicator may be inserted to indicate the position of the sub-band associated with the CQI to an evolved NodeB (eNB). The one or more sub-bands may be configured by an evolved NodeB (eNB). The method may be implemented by mobile user equipment (UE). The UE may be a persistent scheduled UE. Each of the one or more CQIs may utilize two bits on the uplink control channel.

A communications device that is configured to use an uplink control channel to transmit a channel quality indicator (CQI) for sub-bands of a frequency bandwidth is also described. The communications device includes a processor and memory in electronic communication with the processor. Instructions are stored in the memory. The instructions are executable to provide the uplink control channel in a format. The uplink control channel in the format is capable of carrying more than two bits of information. The instructions are executable to insert one or more CQIs into the uplink control channel. Each of the one or more CQIs is associated with one or more sub-bands of the frequency bandwidth. Each CQI uses up to three bits. The instructions are further executable to transmit the one or more CQIs through the uplink control channel from the communications device to a second device. The communications device is in a persistent scheduling mode.

A computer-readable medium comprising executable instructions is also described. The instructions are executable for providing the uplink control channel in a format. The uplink control channel in the format is capable of carrying more than two bits of information. The instructions are also executable for inserting one or more CQIs into the uplink control channel. Each of the one or more CQIs is associated with one or more sub-bands of the frequency bandwidth. Each CQI uses up to three bits. The instructions are also executable for transmitting the one or more CQIs through the uplink control channel from a first device in a persistent scheduling mode to a second device.

A method for allocating resources for an uplink (UL) control channel is also described. An application type of a user equipment (UE) is determined. A format type for the UL control channel is determined. Resources for the UL control channel are reserved based on the application type and the format type. The format type permits more than two bits to be carried on the UL control channel. The UE is informed of the reserved resources. The UL control channel is received. The UL control channel includes one or more channel quality indicators (CQIs) for one or more sub-bands of a frequency bandwidth. Each CQI uses up to three bits.

A base station that is configured to allocate resources for an uplink (UL) control channel is also described. The base station includes a processor and memory in electronic communication with the processor. Instructions are stored in the memory. The instructions are executable to determine an application type of a user equipment (UE) and determine a format type for the UL control channel. The instructions are also executable to reserve resources for the UL control channel based on the application type and the format type. The format type permits more than two bits to be carried on the UL control channel. The instructions are further executable to inform the UE of the reserved resources and receive the UL control channel. The UL control channel includes one or more channel quality indicators (CQIs) for one or more sub-bands of a frequency bandwidth. Each CQI uses up to three bits.

The Third Generation Partnership Project (3GPP) includes a project known as Long Term Evolution (LTE) which strives to improve the Universal Mobile Telecommunication System (UMTS) mobile phone standard to cope with future requirements. Systems implementing these LTE improvements (hereafter, “LTE systems”) may experience improved efficiency, lower costs, improved services, new spectrum opportunities, improved integration with other standards, etc. Communication applications, such as Voice over Internet Protocol (VoIP) may be implemented in LTE systems.

LTE systems include the concepts of dynamic scheduling and persistent scheduling. Dynamic scheduling implies that a piece of mobile user equipment (UE) sends a resource request to an evolved NodeB (eNB) for every packet (such as a VoIP packet) that is to be received or transmitted by the UE. A UE may be a mobile device, mobile station, mobile communications device, access terminal, etc. The eNB may allocate uplink resources for every packet and every retransmission separately during dynamic scheduling. The eNB may be a base station, access point, etc.

One drawback of dynamic scheduling is the large amount of signaling between the UE and the eNB. For example, in dynamic scheduling, almost 15 levels of modulation and coding schemes (MCS) may be considered for each resource request that is received on the uplink. In one example, “uplink” (UL) refers to communications from the UE to the eNB and “downlink” (DL) refers to communications from the eNB to the UE.

In order to reduce the amount of signaling, persistent scheduling may be used. In persistent scheduling, a sequence of resources as well as a fixed MCS may be allocated to the UE at the beginning of an active period or inactive period. In one example, an active period signifies the time the UE is transmitting voice packets, and the inactive period represents the time the UE is receiving silence identification (SID) packets. The allocation of resources and the MCS may be valid until the UE receives another allocation, which may then override the previous allocation. In persistent scheduling, four levels (or less) of MCS may be considered (as opposed to 15 levels of MCS in dynamic scheduling).

The allocation of the MCS may be decided by the eNB depending on a Channel Quality Indicator (CQI) value that is sent from the UE. The CQI may be used for carrier to interference (C/I) feedback of a DL channel. The CQI may be transmitted to the eNB through a dedicated UL control channel, such as a Physical Uplink Control Channel (PUCCH). In previous systems the set of bits for the CQI is fixed in both the dynamic scheduling mode and the persistent scheduling mode.

Proposals have been made to change the number of CQI bits depending on the scheduling mode (i.e., the persistent scheduling mode or the dynamic scheduling mode). For example, the number of bits for the CQI may be reduced for persistent scheduled VoIP traffic. Specifically, the number of bits may be reduced for VoIP DL talkspurt traffic. Talkspurt traffic may indicate that the UE is in an active state and is receiving or transmitting voice packets. During a DL silence period, SID packets may be received by the UE and no CQI information is transmitted. In one example, the number of CQI bits for persistent scheduled VoIP DL talkspurt traffic is reduced to two. As previously stated, four levels (or less) of MCS may be considered in persistent scheduling mode. As such, reducing the number of CQI bits to two may be sufficient for persistent scheduling of resources for UEs.

Currently, three format types exist for a UL control channel that is used to carry the CQI information and the ACK/NACK information from the UE to the eNB. In one configuration, the UL control channel is a PUCCH. A first format (hereinafter, “Format 0”) and a second format (hereinafter, “Format 1”) are currently used to carry ACK/NACK information. A third format (hereinafter, “Format 2”) may be used to carry CQI information and ACK/NAK information. Format 0 may indicate that one bit is carried on the PUCCH. Format 1 may indicate that two bits are carried on the PUCCH. Format 2 may indicate that up to 10 bits are carried on the PUCCH to the eNB. In LTE, there are also Format 2a and Format 2b which are variations of Format 2. Format 2 may include Format 2a and Format 2b.

Proposals have been made to utilize Format 1 to carry the CQI information during persistent scheduling. This proposal has been made since resources may be wasted if Format 2 (which includes up to 10 bits) carries the CQI information during persistent scheduling. As previously explained, the CQI information may be reduced to just 2 bits during persistent scheduling. Table 1 provides possible formats of the control channel (i.e., the PUCCH).

TABLE 1
Possible formats of PUCCH

| Format Type | Capacity | | Contents |
|---|---|---|---|
| Format 0 | 1 | bit | ACK/NACK |
| Format 1 | 2 | bits | ACK/NACK |
| | | | CQI for persistent scheduling |
| Format 2 | Up to 10 | bits | CQI for dynamic scheduling + ACK/ |
| | | | NACK |

LTE systems that employ VoIP applications may include a wideband packet data communication system that utilizes a modulation scheme for transmitting data over an air interface. In LTE systems, a frequency bandwidth may be split into multiple frequency sub-bands, or subcarriers, that include the physical layer channels over which traffic and signaling channels are transmitted simultaneously. A UE may be assigned one or more of the frequency sub-bands for an exchange of information with a serving eNB.

However, the CQI information in the above proposal (i.e., utilizing Format 1 to carry CQI information during persistent scheduling) provides the DL channel condition over the entire bandwidth. Providing CQI information that covers the full bandwidth of a channel may not lead to an efficient utilization of the CQI information. In addition, system performance may decrease due to frequency selective scheduling associated with VoIP applications. As such, the present systems and methods utilize Format 2 of the UL control channel to carry multi-band CQI information, where the number of bits for the CQI information is optimized for VoIP applications.

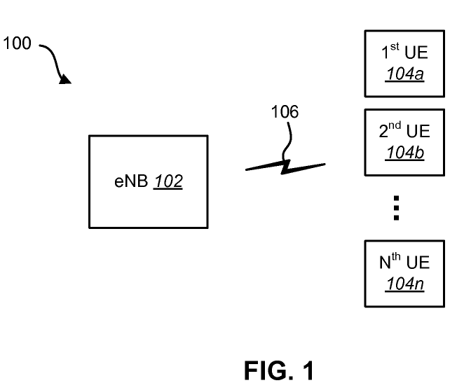

FIG. 1 illustrates an exemplary wireless communication system 100 in which various configurations may be practiced. An Evolved NodeB (eNB) 102 is in wireless communication with one or more pieces of mobile user equipment (UE) 104 (which may also be referred to as mobile stations, user devices, communications devices, subscriber units, access terminals, terminals, etc.). The eNB 102 may also be referred to as a base station.

The eNB 102 may be a unit adapted to transmit to and receive data from cells. In one example, the eNB 102 handles the actual communication across a radio interface, covering a specific geographical area, also referred to as a cell. Depending on sectoring, one or more cells may be served by the eNB 102, and accordingly the eNB 102 may support one or more mobile UEs 104 depending on where the UEs are located. In one example, the eNB 102 provides a Long Term Evolution (LTE) air interface and performs radio resource management for the communication system 100.

A first UE 104a, a second UE 104b, and an Nth UE 104n are shown in FIG. 1. The eNB 102 transmits data to the UEs 104 over a radio frequency (RF) communication channel 106. The transmitted data may include a plurality of LTE frames. Each of the LTE radio frames may have a length of 10 ms.

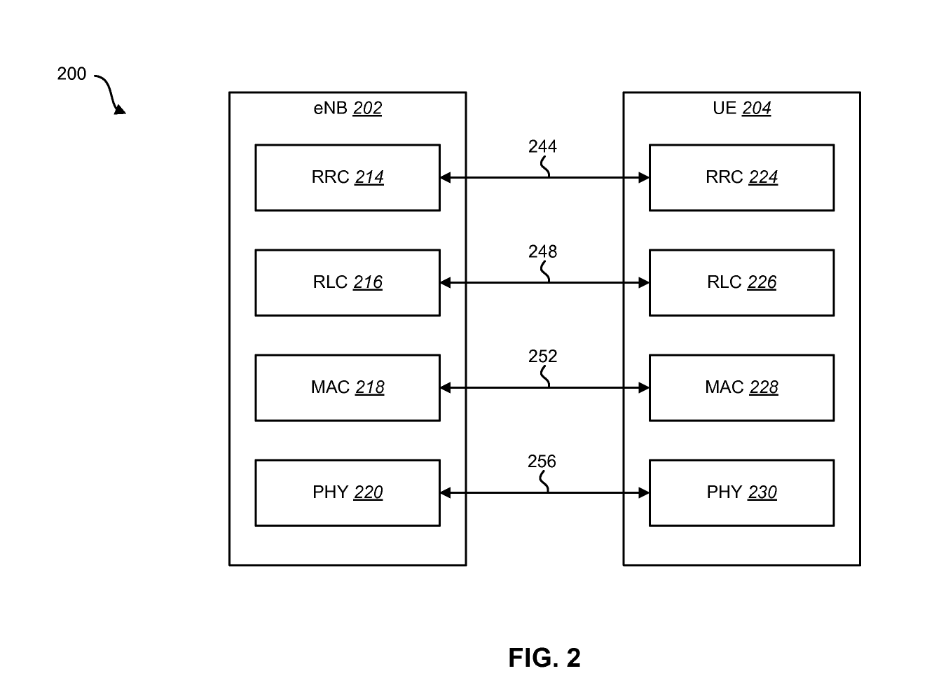

FIG. 2 is an exemplary diagram 200 of a portion of the protocol stacks for the control plane of a UE 204 and an eNB 202. The exemplary protocol stacks provide radio interface architecture between the eNB 202 and the UE 204. In one configuration, the control plane includes a Layer 1 stack that includes a physical (PHY) layer 220, 230, a Layer 2 stack that includes a medium access control (MAC) layer 218, 228, and a Radio Link Control (RLC) layer 216, 226, and a Layer 3 stack that includes a Radio Resource Control (RRC) layer 214, 224.

The RRC layer 214, 224 is generally a Layer 3 radio interface adapted to provide an information transfer service to the non-access stratum. The RRC layer 214, 224 of the present systems and methods may transfer Channel Quality Indicator (CQI) information and Acknowledgement/Non-Acknowledgment (ACK/NACK) information from the UE 204 to the eNB 202. The RRC layer 214, 224 may also provide RRC connection management.

The RLC layer 216, 226 is a Layer 2 radio interface adapted to provide transparent, unacknowledged, and acknowledged data transfer service. The MAC layer 218, 228 is a radio interface layer providing unacknowledged data transfer service on the logical channels and access to transport channels. The MAC layer 218, 228 may be adapted to provide mappings between logical channels and transport channels.

The PHY layer 220, 230 generally provides information transfer services to the MAC layer 218, 228 and other higher layers 216, 214, 226, 224. Typically the PHY layer 220, 230 transport services are described by their manner of transport. Furthermore, the PHY layer 220, 230 may be adapted to provide multiple control channels. In one embodiment, the UE 204 is adapted to monitor this set of control channels. Furthermore, as shown, each layer communicates with its compatible layer via a communications link 244, 248, 252, 256.

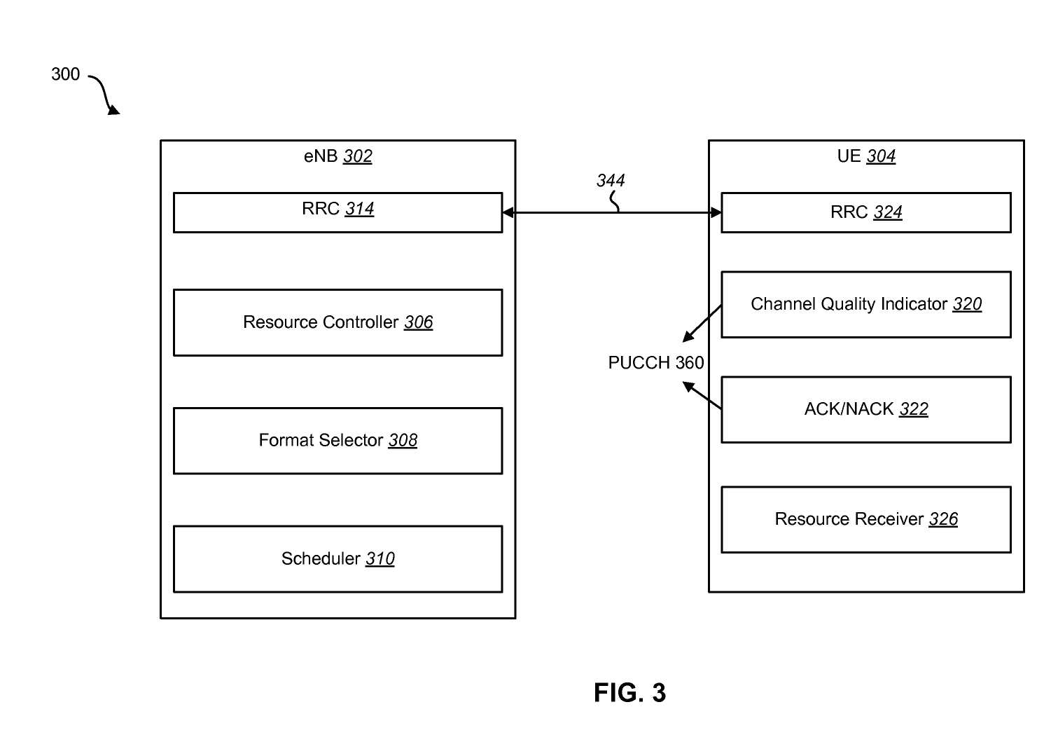

FIG. 3 is a block diagram 300 illustrating one example of the eNB 302 and the UE 304. The eNB 302 may include a resource controller 306 that allocates resources to the UE 304. The UE 304 may utilize these resources to send information to and receive information from the eNB 302. In one configuration, the resource controller 306 allocates resources for a Physical Downlink Shared Channel (PDSCH) and a Physical Uplink Shared Channel (PUSCH). In addition, the resource controller 306 may allocate resources for a Physical Hybrid Automatic Request Indicator Channel (PHICH). The PHICH may be utilized to carry ACK/NACK information on a downlink (i.e., from the eNB 302 to the UE 304). Further, the controller 306 may also allocate resources for a Physical Uplink Control Channel (PUCCH) 360. The PUCCH 360 may be utilized to carry ACK/NACK information 322 and CQI information 320 from the UE 304 to the eNB 302 on an uplink.

In one example, the allocation of resources for the PUCCH 360 may include information regarding the time and frequency associated with the PUCCH 360. The allocation of resources for the PUCCH 360 may also include information regarding a UE index (cyclic shift and block-wise spreading code). Further, the allocation resources for the PUCCH 360 may indicate to the UE 304 which format of the PUCCH 360 is to be utilized. A format selector 308 may be used to select the format type of the PUCCH 360. In one example, the PUCCH 360 includes three format types (e.g., Format 0, Format 1 and Format 2). Details regarding these different format types will be discussed below.

The eNB 302 may also include a scheduler 310 that schedules information received from the UE 304 into one or more subframes of the LTE radio frames. In one configuration, the scheduler 310 allocates different subframes for CQI information 320 and ACK/NACK information 322 received from the UE 304.

The UE 304 may include a resource receiver 326 that receives the allotment of resources from the eNB 302. The receiver 326 also determines the format type of the PUCCH 360. Based upon the determined format type, the UE 304 transmits information on the PUCCH 360. Possible examples of information that may be transmitted on the PUCCH 360 include the CQI 320 and the ACK/NACK 322. The UE 304 includes the RRC layer 324 and may communicate with the eNB 302 through RRC signaling 344 with the corresponding RRC layer 314 of the eNB 302.

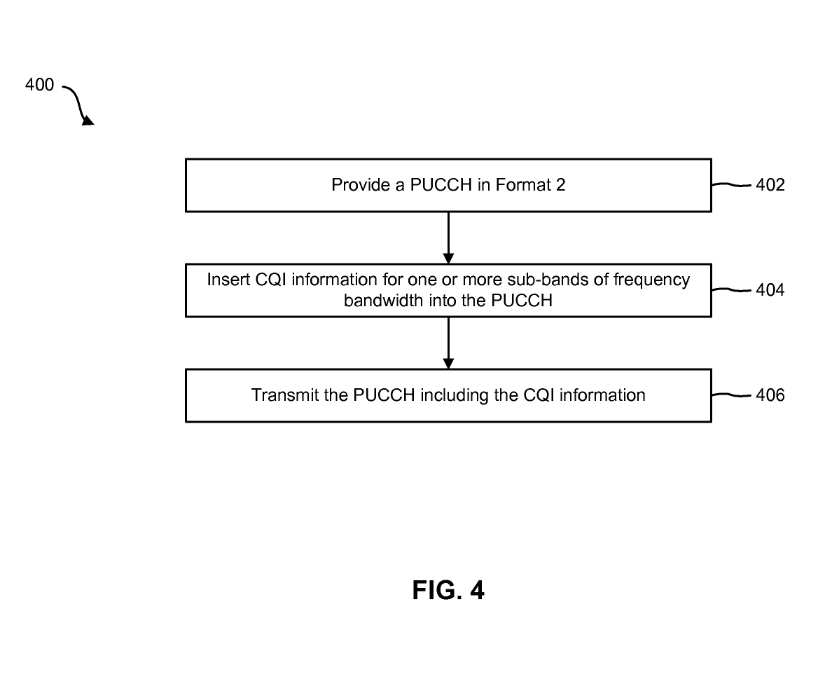

FIG. 4 is a flow diagram illustrating one example of a method 400 for providing CQI in a UL control channel for one or more sub-bands of a frequency bandwidth. The method 400 may be implemented by the UE 104. In one example, a UL control channel may be provided 402 in Format 2. The UL control channel may be the PUCCH 360. The PUCCH 360 may be provided in Format 2. In other words, the PUCCH 360 may carry up to 10 bits of information to the eNB.

In one configuration CQI information may be inserted 404 into the PUCCH 360. CQI information may be associated with one or more sub-bands of a frequency bandwidth. The CQI information for each sub-band may utilize the same number of bits previously proposed to carry CQI information for persistent scheduling. In one example, the CQI information associated with each sub-band may be 2 bits. The PUCCH 360, including the CQI information, may be transmitted 406 to a receiver. In one example, the receiver is the eNB 102.

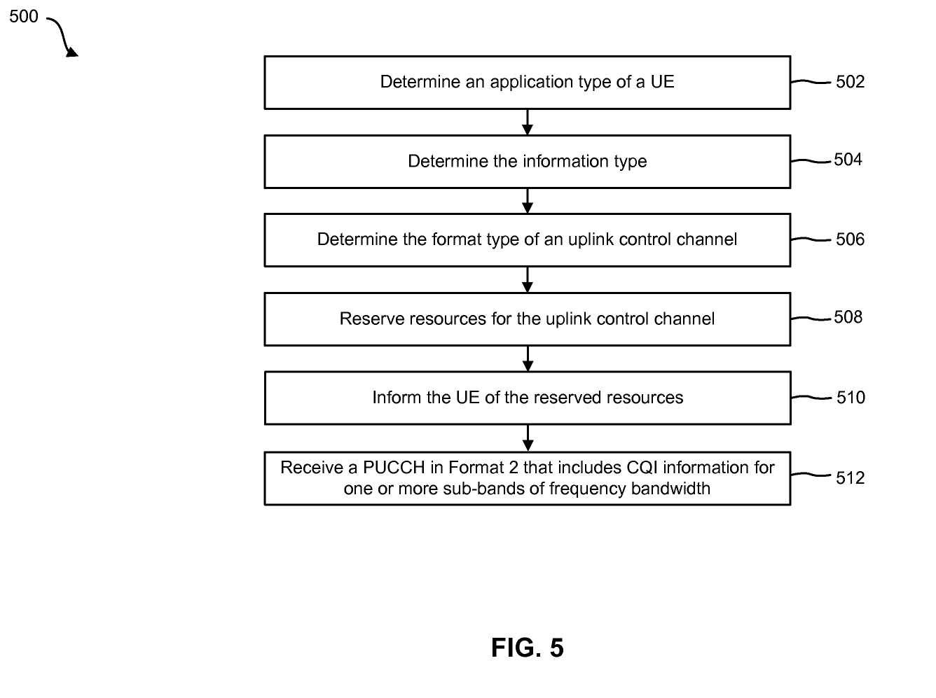

FIG. 5 is a flow diagram illustrating one example of a method 500 for allocating resources for a UL control channel, such as the PUCCH 360. The method 500 may be implemented by the eNB 102. In one example, application type of a UE 104 is determined 502. For example, the application type a VoIP application. VoIP applications are used for the transmission of voice through the Internet or other packet switched networks.

The information type may be determined 504. For example, the type of information that is to be received may be determined 504 (e.g., CQI information, ACK/NACK information, etc.) The format type for the UL control channel may also be determined 506. In one example, it is determined 506 that the format type for the UL control channel (i.e., the PUCCH 360) is Format 2 if persistent scheduling is used for CQI information.

Resources for the UL control channel may be reserved 508. Resources may include time, frequency, determined format type (e.g, Format 0, Format 1, Format 2), UE index (cyclic shift and block-wise spreading code), etc. The UE 104 may be informed 510 of the reserved resources. In one configuration, the UL control channel may be received 512 in Format 2. For example, the PUCCH 360 in Format 2 may be received 512. The PUCCH 360 may include CQI information for one or more sub-bands of a frequency bandwidth.

In one configuration, current systems and methods use b bits to represent a CQI differential value. The CQI differential value may be used to minimize the size of the CQI message transmitted on the PUCCH 360. The CQI differential value may indicate a change in the channel quality of the sub-band that was selected for reporting, whose CQI information was reported in an immediately preceding CQI message. For example, if the CQI information reported for a selected sub-band in a preceding CQI message includes a voltage associated with a measured channel quality, the CQI differential value may be a value associated with a change in such a voltage, such as a binary value corresponding to a change in decibels (dBs), resulting from a re-measuring of the sub-band's channel quality during the most recent measuring period. Under the present systems and methods, b<k bits may be used to represent the CQI differential value, where k bits represent the number of bits used to carry the CQI information during persistent scheduling.

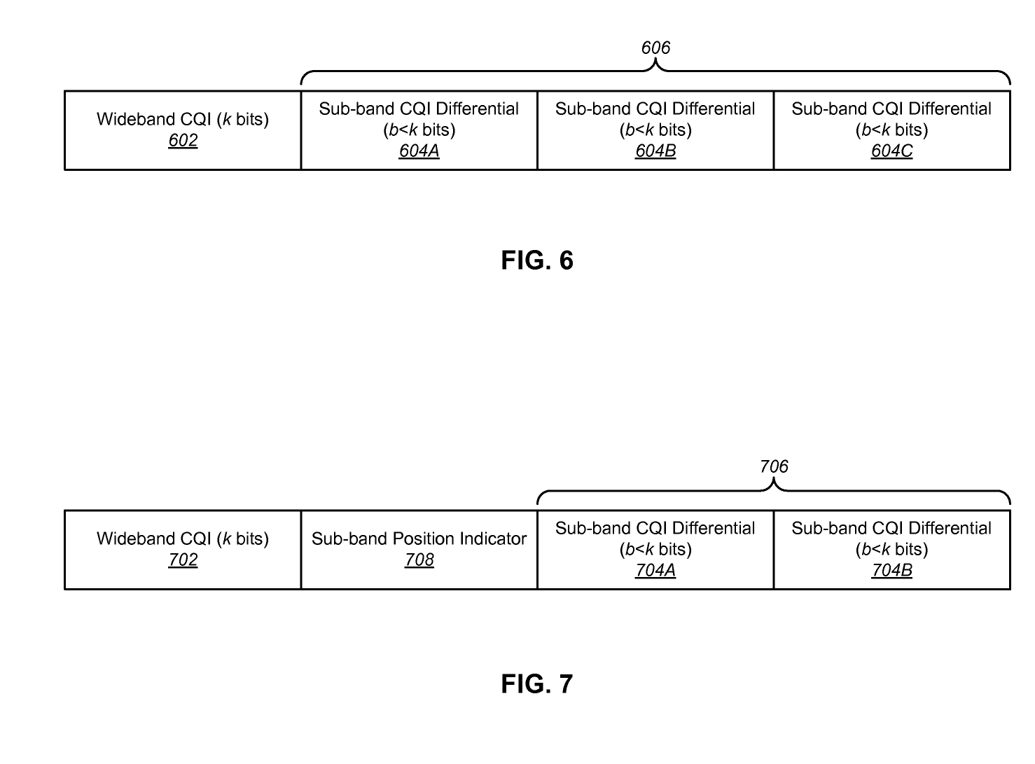

FIGS. 6-9 illustrate various distributions of information that may be carried by a UL control channel, such as the PUCCH 360. The information carried may include CQI information. Format 2 of the PUCCH 360 may be used to carry the information. As previously mentioned, Format 2 of the PUCCH 360 may facilitate the PUCCH 360 to carry up to 10 bits of information from the UE 104 to the eNB 102.

FIG. 6 is a block diagram illustrating one example of the distribution of CQI differential information for VoIP carried on the PUCCH 360 when multiple sub-bands are configured by the eNB 102. In other words, the eNB 102 instructs the UE 104 which sub-bands the UE 104 should provide CQI information for. The UE 104 may transmit CQI information for each sub-band indicated by the eNB 102. The eNB 102 may communicate which sub-bands the UE 104 should provide CQI information for via RRC signaling.

As illustrated, the PUCCH 360 may include a single wideband CQI 602 with k bits. In one example, k is two bits for persistent scheduling. CQI information for multiple eNB configured sub-bands 606 may also be included in the PUCCH 360. In one configuration, the multiple eNB configured sub-bands 606 are represented by m sub-band CQI differential values 606. Each sub-band CQI differential value 604A, 604B, 604C may be b bits, where b is less than k. In one example, b is a single bit. In addition, the eNB 102 is aware of the location of the sub-band. As such, the PUCCH 360 may not include information regarding the location of the sub-band.

FIG. 7 is a block diagram illustrating another example of the distribution of CQI differential information for VoIP carried on the PUCCH 360 when multiple sub-bands are selected by the UE 104. In other words, the UE 104 determines which sub-bands the UE 104 will provide CQI information for to the eNB. The UE 104 may transmit CQI information for each selected sub-band to the eNB 102.

In one example, the PUCCH 360 includes a single wideband CQI 702 of k bits. The PUCCH 360 may also include m differential CQI values 706 for multiple sub-bands 704A, 704B. In one configuration, the multiple sub-bands may be selected by the UE 104. The eNB 102 may not be aware of the position information for the sub-bands. As such, the PUCCH 360 may include a sub-band position indicator 708 that identifies the position of a particular sub-band to the eNB 102.

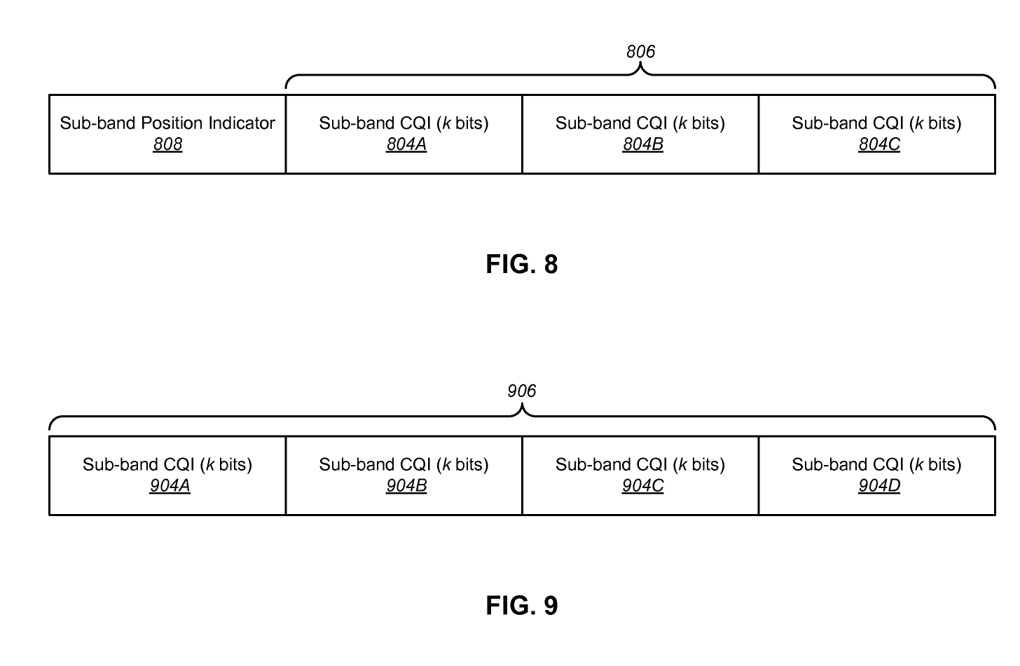

FIG. 8 is a block diagram illustrating an example of the distribution of CQI information for VoIP carried on the PUCCH 360 when multiple sub-bands are selected by the UE 104. As illustrated, m sub-band CQI values 806 for multiple eNB configured sub-bands may be carried by the PUCCH 360. Each of the sub-band CQI values 804A, 804B, 804C may include k bits. If persistent scheduling is utilized, k may be 2 bits. The position information for each of the multiple sub-bands may not be known by the eNB 102. A sub-band position indicator 808 may also be carried by the PUCCH 360 to provide the position of the multiple sub-bands to the eNB 102.

FIG. 9 is a block diagram illustrating an example of the distribution of CQI information for VoIP carried on the PUCCH 360 when multiple sub-bands are configured by the eNB 102. As illustrated, m sub-band CQI values 906 for multiple eNB configured sub-bands may be carried by the PUCCH 360. Each of the sub-band CQI values 904A, 904B, 904C, 904D may include k bits. If persistent scheduling is utilized, k may be 2 bits. The position information for each of the multiple sub-bands may be known by the eNB 102. A sub-band position indicator may not be included in the PUCCH 360.

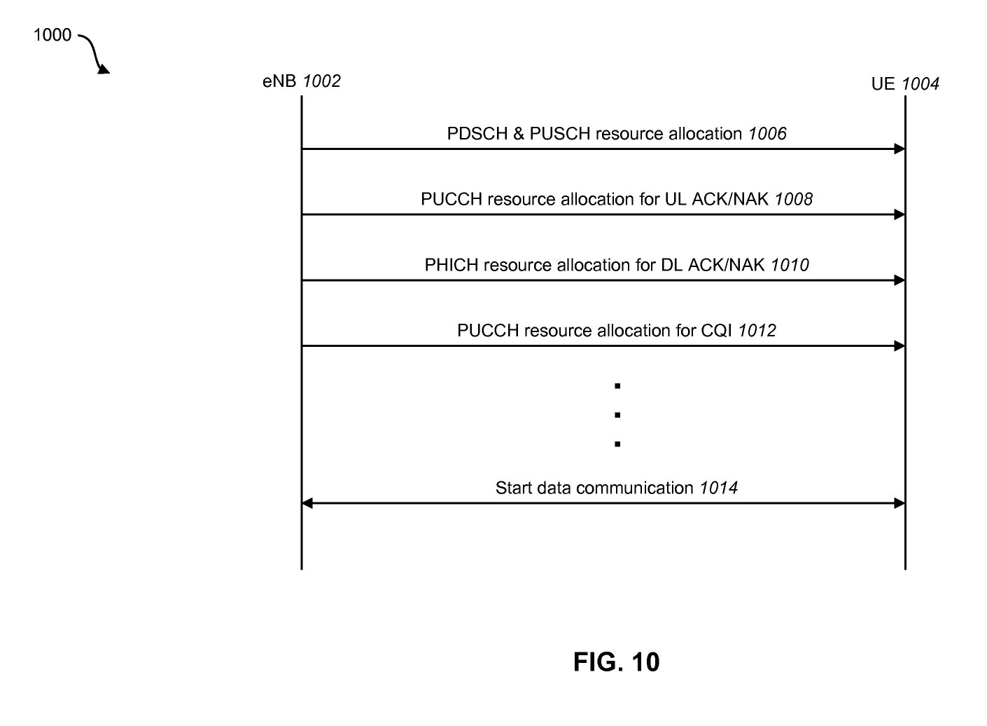

FIG. 10 is a thread diagram 1000 illustrating one example of persistent scheduling communication in accordance with the present systems and methods. In one configuration, before data communication is started 1014, the eNB 1002 informs the allocation of resources to the UE 1004 via RRC signaling 344. For example, the resources for the PDSCH and the PUSCH may be allocated 1006 to the UE 1004. In addition, the resources for UL ACK/NACK on the PUCCH may also be allocated 1008. The eNB 1002 may further allocate 1010 resources for DL ACK/NACK. The DL ACK/NACK may be carried on the PHICH. Further, resources may be allocated 1012 for CQI information that is carried on the PUCCH. Additional resources may be allocated that are not shown in FIG. 10. Once the resources have been allocated, data communications may start 1014 between the eNB 1002 to the UE 1004. The UE 1004 may be a persistent scheduled UE.

In one example, the PUCCH resource allocation 1008, 1012 may include the time and frequency of the PUCCH. In addition, the resource allocation 1008, 1012 may include the format type (i.e., Format 0, Format 1 or Format 2) of the PUCCH. The PUCCH resource allocation 1008, 1012 may also include information relating to the UE index (cyclic shift and block-wise spreading codes). The eNB 1002 and the UE 1004 may know which cyclic shift and block-wise spreading codes are allocated for the UE 1004 in persistent scheduling mode. In another example, the eNB 1002 may communicate with a dynamic scheduled UE and a persistent scheduled UE at the same time based on a configuration provided from RRC signaling 344.

The RRC signaling 344 may also inform the UE 1004 to use k bits for the CQI information (e.g. 2 bits). In addition, the RRC signaling 344 may inform the UE 1004 that multiple sub-band differential CQI values may use b bits, where b is less than k.

As shown in FIG. 10, the eNB 1002 may provide the resource allocation parameters for the PUCCH to each persistent scheduled UE. However, for dynamic scheduling, the eNB 1002 may reserve a set of allocation parameters for dynamic scheduled UEs. Otherwise, resources for a dynamic scheduled UE and a persistent scheduled UE may conflict.

The present systems and methods use VoIP applications as one example of persistent (or semi-persistent) scheduled applications. The present systems and methods may apply to other such types of applications, such as, but not limited to, on-line gaming applications. In addition, the present systems and methods described herein relate to 3GPP LTE systems. However, the present systems and methods may be utilized for other OFDM communication systems, such as, for example IEEE 802.16m.

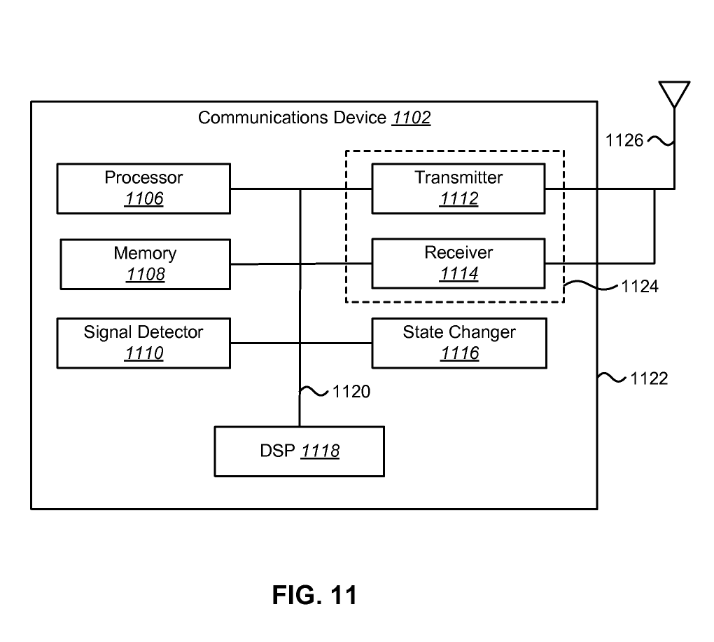

FIG. 11 illustrates various components that may be utilized in a communications device 102, such as a UE 104, in accordance with one configuration. The device 1102 includes a processor 1106 which controls operation of the device 1102. The processor 1106 may also be referred to as a CPU.

Memory 1108, which may include both read-only memory (ROM) and random access memory (RAM), provides instructions and data to the processor 1106. A portion of the memory 1108 may also include non-volatile random access memory (NVRAM). The memory 1108 may include any electronic component capable of storing electronic information, and may be embodied as ROM, RAM, magnetic disk storage media, optical storage media, flash memory, on-board memory included with the processor 1106, EPROM memory, EEPROM memory, registers, a hard disk, a removable disk, a CD-ROM, etc. The memory 1108 may store program instructions and other types of data. The program instructions may be executed by the processor 1106 to implement some or all of the methods disclosed herein.

The device 1102 may also include a housing 1122 that includes a transmitter 1112 and a receiver 1114 to allow transmission and reception of data between the communications device 1102 and a remote location. The transmitter 1112 and receiver 1114 may be combined into a transceiver 1124. An antenna 1126 is attached to the housing 1122 and electrically coupled to the transceiver 1124.

The communications device 1102 also includes a signal detector 1110 used to detect and quantify the level of signals received by the transceiver 1124. The signal detector 1110 detects such signals as total energy, power spectral density and other signals.

A state changer 1116 of the device 1102 controls the state of the device 1102 based on a current state and additional signals received by the transceiver 1124 and detected by the signal detector 1110. The device 1102 is capable of operating in any one of a number of states.

The various components of the device 1102 are coupled together by a bus system 1120 which may include a power bus, a control signal bus, and a status signal bus in addition to a data bus. However, for the sake of clarity, the various busses are illustrated in FIG. 11 as the bus system 1120. The device 1102 may also include a digital signal processor (DSP) 1118 for use in processing signals.

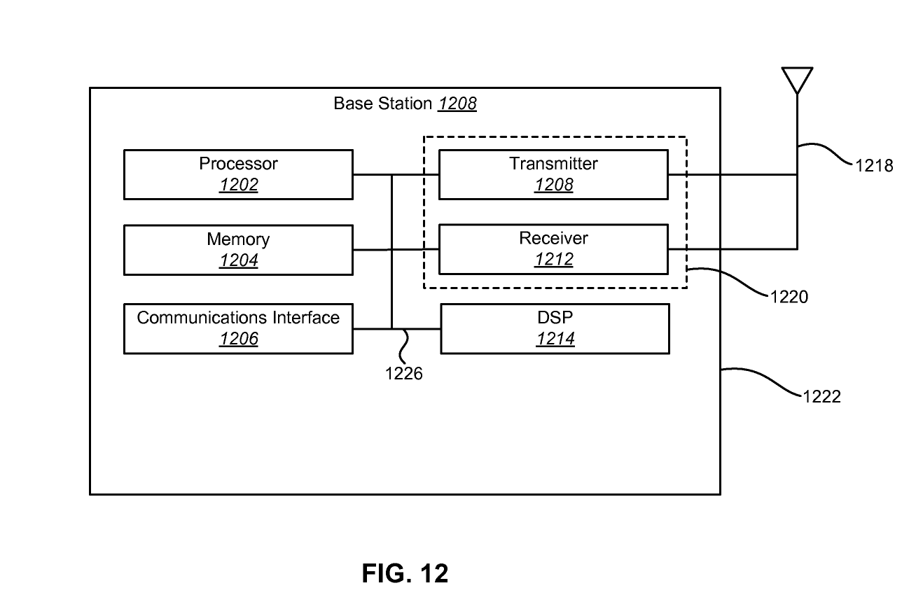

FIG. 12 is a block diagram of a base station 1208 in accordance with one example of the disclosed systems and methods. The base station 1208 may be an eNB 102, a base station controller, a base station transceiver, etc. The base station 1208 includes a transceiver 1220 that includes a transmitter 1210 and a receiver 1212. The transceiver 1220 may be coupled to an antenna 1218. The base station 1208 further includes a digital signal processor (DSP) 1214, a general purpose processor 1202, memory 1204, and a communication interface 1206. The various components of the base station 1208 may be included within a housing 1222.

The processor 1202 may control operation of the base station 1208. The processor 1202 may also be referred to as a CPU. The memory 1204, which may include both read-only memory (ROM) and random access memory (RAM), provides instructions and data to the processor 1202. A portion of the memory 1204 may also include non-volatile random access memory (NVRAM). The memory 1204 may include any electronic component capable of storing electronic information, and may be embodied as ROM, RAM, magnetic disk storage media, optical storage media, flash memory, on-board memory included with the processor 1202, EPROM memory, EEPROM memory, registers, a hard disk, a removable disk, a CD-ROM, etc. The memory 1204 may store program instructions and other types of data. The program instructions may be executed by the processor 1202 to implement some or all of the methods disclosed herein.

In accordance with the disclosed systems and methods, the antenna 1218 may receive reverse link signals that have been transmitted from a nearby communications device 1102, such as a UE 104. The antenna 1218 provides these received signals to the transceiver 1220 which filters and amplifies the signals. The signals are provided from the transceiver 1220 to the DSP 1214 and to the general purpose processor 1202 for demodulation, decoding, further filtering, etc.

The various components of the base station 1208 are coupled together by a bus system 1226 which may include a power bus, a control signal bus, and a status signal bus in addition to a data bus. However, for the sake of clarity, the various busses are illustrated in FIG. 12 as the bus system 1226.

As used herein, the term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

The various illustrative logical blocks, modules and circuits described herein may be implemented or performed with a general purpose processor, a digital signal processor (DSP), an application specific integrated circuit (ASIC), a field programmable gate array signal (FPGA) or other programmable logic device, discrete gate or transistor logic, discrete hardware components or any combination thereof designed to perform the functions described herein. A general purpose processor may be a microprocessor, but in the alternative, the processor may be any conventional processor, controller, microcontroller or state machine. A processor may also be implemented as a combination of computing devices, e.g., a combination of a DSP and a microprocessor, a plurality of microprocessors, one or more microprocessors in conjunction with a DSP core or any other such configuration.

The steps of a method or algorithm described herein may be embodied directly in hardware, in a software module executed by a processor or in a combination of the two. A software module may reside in any form of storage medium that is known in the art. Some examples of storage media that may be used include RAM memory, flash memory, ROM memory, EPROM memory, EEPROM memory, registers, a hard disk, a removable disk, a CD-ROM and so forth. A software module may comprise a single instruction, or many instructions, and may be distributed over several different code segments, among different programs and across multiple storage media. An exemplary storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

The functions described may be implemented in hardware, software, firmware, or any combination thereof. If implemented in software, the functions may be stored as one or more instructions on a computer-readable medium. A computer-readable medium may be any available medium that can be accessed by a computer. By way of example, and not limitation, a computer-readable medium may comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

It is to be understood that the claims are not limited to the precise configuration and components illustrated above. Various modifications, changes and variations may be made in the arrangement, operation and details of the systems, methods, and apparatus described herein without departing from the scope of the claims.

What is claimed is:

1. A method for using an uplink control channel to transmit a channel quality: indicator (CQI) for sub-bands of a frequency bandwidth, comprising:
providing the uplink control channel in a format, wherein the uplink control channel in the format is capable of carrying more than two bits of information;
inserting one or more CQIs into the uplink control channel, wherein each of the one or more CQIs is associated with one or more sub-bands of the frequency bandwidth and wherein each CQI uses up to three bits; and
transmitting the one or more CQIs through the uplink control channel from a first device in a persistent scheduling mode to a second device.

2. The method of claim 1, wherein the uplink control channel is a Physical Uplink Control Channel (PUCCH).

3. The method of claim 1, wherein the uplink control channel is in Format 2 and carries up to ten bits of information.

4. The method of claim 1, further comprising inserting one or more CQI differential values into the uplink control channel.

5. The method of claim 4, wherein the CQI differential value uses a single bit.

6. The method of claim 1, wherein the one or more sub-bands are selected by mobile user equipment (UE).

7. The method of claim 6, further comprising inserting a sub-band position indicator to indicate the position of the sub-band associated with the CQI to an evolved NodeB (eNB).

8. The method of claim 1, wherein the one or more sub-bands are configured by an evolved NodeB (eNB).

9. The method of claim 1, wherein the method is implemented by mobile user equipment (UE), wherein the UE is a persistent scheduled UE.

10. The method of claim 1, wherein each of the one or more CQIs utilize two bits on the uplink control channel.

11. A communications device that is configured to use an uplink control channel to transmit a channel quality indicator (CQI) for sub-bands of a frequency bandwidth, the communications device comprising:
a processor;
memory in electronic communication with the processor;
instructions stored in the memory, the instructions being executable to:
provide the uplink control channel in a format, wherein the uplink control channel in the format is capable of carrying more than two bits of information;
insert one or more CQIs into the uplink control channel, wherein each of the one or more CQIs is associated with one or more sub-bands of the frequency bandwidth and wherein each CQI uses up to three bits; and
transmit the one or more CQIs through the uplink control channel from the communications device to a second device, wherein the communications device is in a persistent scheduling mode.

12. The communications device of claim 11, wherein the uplink control channel is a Physical Uplink Control Channel (PUCCH).

13. The communications device of claim 11, wherein the uplink control channel in Format 2 and carries up to ten bits of information.

14. The communications device of claim 11, wherein the instructions are further executable to insert one or more CQI differential values into the uplink control channel.

15. The communications device of claim 14, wherein the CQI differential value uses a single bit.

16. The communications device of claim 11, wherein the one or more sub-bands are selected by mobile user equipment (UE).

17. The communications device of claim 11, wherein the instructions are further executable to insert a sub-band position indicator to indicate the position of the sub-band associated with the CQI to an evolved NodeB (eNB).

18. The communications device of claim 11, wherein the one or more sub-bands are configured by an evolved NodeB (eNB).

19. The communications device of claim 11, wherein the communications device is mobile user equipment (UE), wherein the UE is a persistent scheduled UE.

20. The communications device of claim 11, wherein each of the one or more CQIs utilize two bits on the uplink control channel.

21. A computer-readable medium comprising executable instructions for:
providing the uplink control channel in a format, wherein the uplink control channel in the format is capable of carrying more than two bits of information;
inserting one or more CQIs into the uplink control channel, wherein each of the one or more CQIs is associated with one or more sub-bands of the frequency bandwidth and wherein each CQI uses up to three bits; and
transmitting the one or more CQIs through the uplink control channel from a first device in a persistent scheduling mode to a second device.

22. A method for allocating resources for an uplink (UL) control channel, the method comprising:
determining an application type of a user equipment (UE);
determining a format type for the UL control channel;
reserving resources for the UL control channel based on the application type and the format type, wherein the format type permits more than two bits to be carried on the UL control channel;
informing the UE of the reserved resources; and
receiving the UL control channel, wherein the UL control channel includes one or more channel quality indicators (CQIs) for one or more sub-bands of a frequency bandwidth, wherein each CQI uses up to three bits.

23. A base station that is configured to allocate resources for an uplink (UL) control channel, the base station comprising:
a processor;
memory in electronic communication with the processor;
instructions stored in the memory, the instructions being executable to:
determine an application type of a user equipment (UE);
determine a format type for the UL control channel;
reserve resources for the UL control channel based on the application type and the format type, wherein the format type permits more than two bits to be carried on the UL control channel;
inform the UE of the reserved resources; and
receive the UL control channel, wherein the UL control channel includes one or more channel quality indicators (CQIs) for one or more sub-bands of a frequency bandwidth, wherein each CQI uses up to three bits.
